(19) United States
(12) Patent Application Publication
(10) Pub. No.: US 2005/0108163 A1
(43) Pub. Date: May 19, 2005

(54) Method and system for processing checks

(76) Inventors: Thomas R. Wells, Crystal Lake, IL (US); Robert A. Zick, Whitehall, PA (US); Michael R. Drago, Bethlehem, PA (US); Ryan S. Adam, Kutztown, PA (US); Russell L. Wald, Bethlehem, PA (US); Phuong Do, Allentown, PA (US)

Correspondence Address: Patula & Associates, P.C., 14th Floor, 116 South Michigan Avenue, Chicago, IL, 60603, US

(21) Appl. No.: 10/717,428

(22) Filed: Nov. 19, 2003

(51) Int. Cl. G06F 17/60

(52) U.S. Cl. 705/42; 705/43; 705/45

(57) ABSTRACT

Returned checks are matched with related bank documents during a mail insertion operation. In the disclosed examples, the method and system utilize an imaging system to read the MICR account code line on each check payment document. The account number data from the check document is then compared to account number data for a related bank document and a match or mismatch is determined.

The present subject matter relates generally to the field of document handling systems. In particular, the present subject matter relates to a method and system for processing checks which verifies that returned checks match corresponding bank statements when inserted into envelopes for mailing. More specifically, the method and system involve optically reading the magnetic ink character recognition code on checks to determine the account number of each check in a batch of checks and to verify that the account number of each check in the batch matches the account number on a corresponding bank statement or document.

### BACKGROUND

Verification systems have been used in combination with an automatic document collating and envelope inserting system for mailing to recipients. In check payment verification systems, returned checks are sorted into batches so that they may then be merged with a bank institution statement and/or other bank documents for mailing. Financial institutions utilize these systems for mailing bank statements and returned checks to checking account customers. Check payment verification systems are used in an attempt to prevent the occurrence of mismatched checks and/or statements in the automated mailing process.

Prior check verification systems count the number of check payment documents and compare the counted number with the expected number of checks for a particular bank statement. The counted checks are then merged with the corresponding bank statement document for insertion into envelopes for mailing to customers. The integrity of these systems is often maintained only by counting the number of checks in a batch and comparing that number to the number of checks required for each corresponding bank statement.

A common problem with such verification systems is that mismatched checks which do not correspond to the correct account number may be inserted into envelopes with the wrong bank statement and mailed even when the check quantity matches. Thus, checking account holders may receive the checks of another account holder and may not receive the checks that correspond to their bank statement and account number. Privacy issues resulting from such errors have become an increasingly important concern, particularly for financial institutions and checking account holders.

There is a need to address the problems and disadvantages of the above described systems by providing a method and system which verifies that each check document matches the other check documents in a batch and/or that the checks in a batch match the corresponding bank statement, by optically reading the magnetic ink character recognition (MICR) account number code line on each check and matching it to the account number of the corresponding bank statement. Such a system overcomes the problems and disadvantages of prior art verification systems, and ensures the accuracy and privacy of financial information such as that regarding personal and/or business checking account transactions and financial data.

### SUMMARY

A method and system are provided for check payment verification which match a set of check payment documents to corresponding bank documents, including but not limited to bank statements, and/or which match each check payment document to each other check payment document in a set, during a mail insertion operation, using an imaging system, in which optical character recognition (OCR) is utilized to read MICR account number data on each check document and account number information on a bank statement.

In the preferred embodiment, an imaging system is utilized with a check feeder device, an automated in-line mailing (AIM) machine, which inserts documents into envelopes for mailing, and a computerized document inserter control system (ICS) which, in combination with an additional computer, regulates the flow of documents through the check feeder and AIM device.

In the preferred embodiment, the imaging system comprises an imaging device at the check feeder, one or more imaging devices at the automatic inserter machine (AIM) and a computer.

The automatic inserter machine imaging device and the check feeder imaging device each further preferably comprise a camera, a light source, and a triggering device. The computer further comprises magnetic ink character recognition (MICR) software, optical character recognition (OCR) software and communications connections to the check feeder, the check feeder imaging device, the AIM imaging device and the inserter control system. The computer may further comprise a computer monitor displaying computer functions. The check feeder device may further comprise a control panel. The check verification system may further comprise a counter.

In operation, the AIM imaging device images each bank document at the AIM, transmits the optical image to the computer where OCR software is used to read all or a portion of the checking account number on the bank document, and the computer transmits the checking account number data to the ICS for buffering the documents or retains it for database lookup. As a collated set of check payment documents enters the check feeder device, the check feeder imaging device images each check or the region of each check having all or at least a portion of the MICR code line where the checking account number in the account code field is printed on each check document. The optical image of the MICR code is then transmitted to the computer where MICR software is used to optically read the account number data. At the completion of feeding a collated set of check payment documents, the account number data from each check payment document is then matched to the account number from the statement previously read at the AIM device and retained within the computer.

The inserter control system then signals the check feeder to dump, and signals the computer that the set has been dumped onto the bank document in front of the check feeder. If no mismatch is detected, the check set will be merged with the bank document for mailing. If an error is detected, the computer will fault and signal the ICS of the fault. The computer will display the checks that are in error, for the operator to review the error. The operator may then choose via the computer monitor whether to allow the set to continue processing or to divert the set for offline handling.

The system may further include several other operator selectable options, such as, but not limited to, check feeder account number masking, character tolerance, set mismatch tolerance, disabling of operator error validation such that all error sets are diverted, parenting of multiple account numbers, all of which are discussed in detail below in the detailed description of the preferred embodiment.

### BRIEF DESCRIPTION OF THE PREFERRED EMBODIMENT

A preferred embodiment of the present invention is described herein with reference to the drawings wherein:

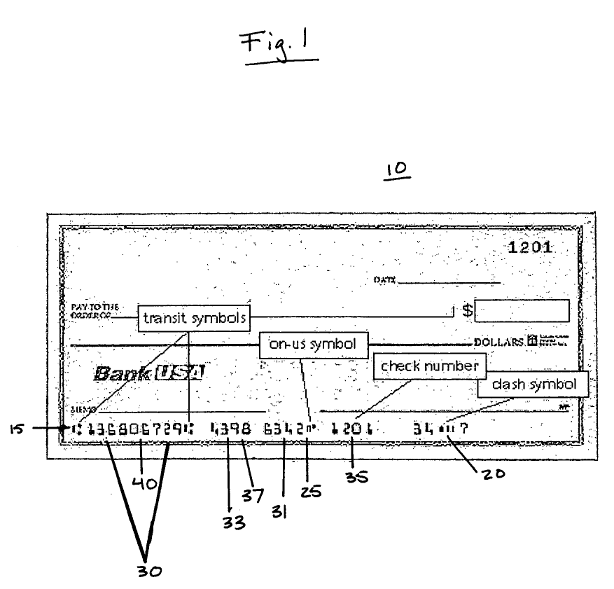

FIG. 1 is a front view of a sample check document displaying a magnetic ink character recognition (MICR) code line.

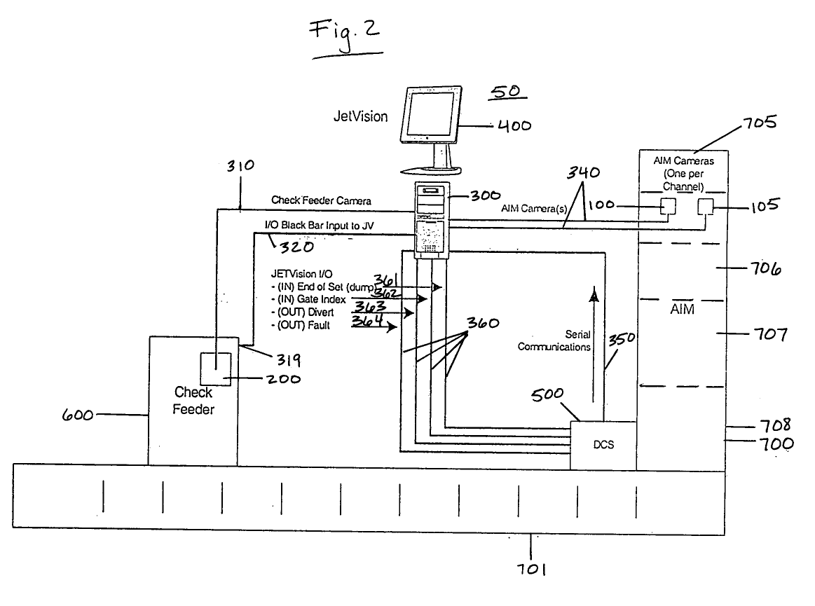

FIG. 2 is a schematic diagram of the present invention;

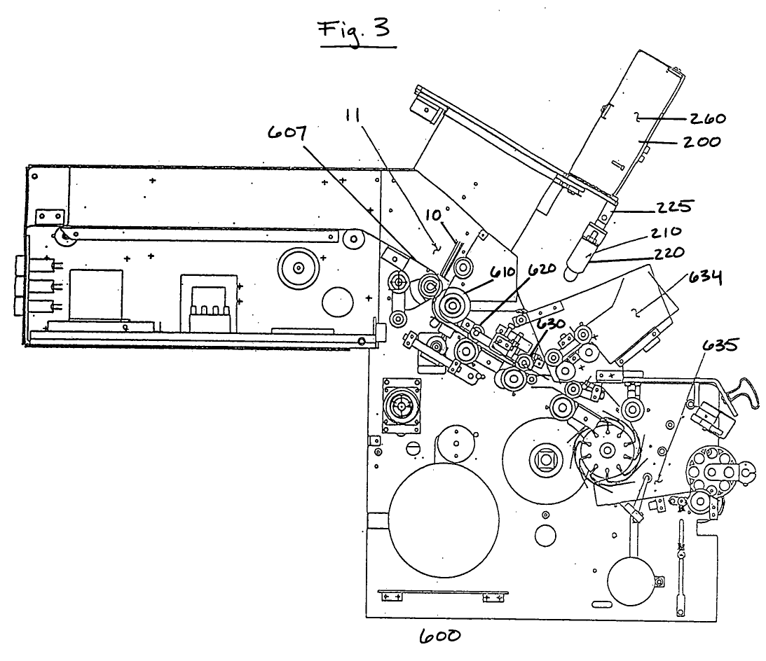

FIG. 3 is a schematic side view of the check feeder device of the present invention;

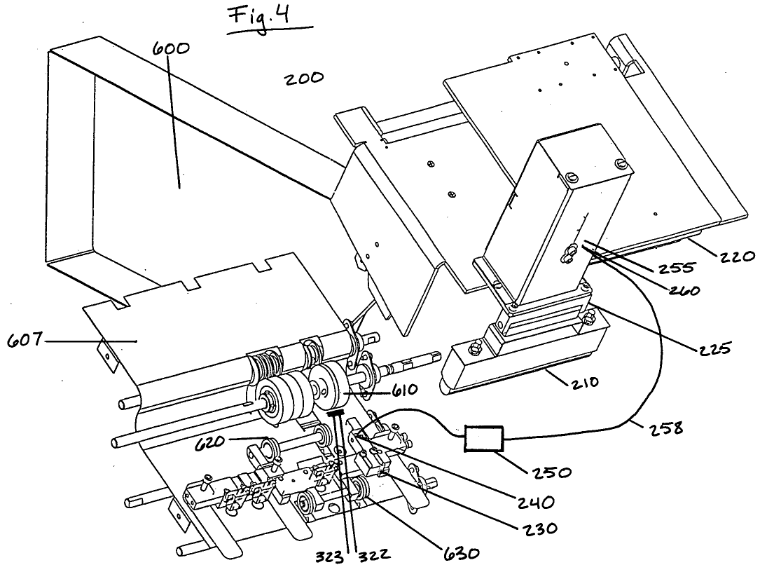

FIG. 4 is a schematic perspective view of the check feeder and imaging device of the present invention; and

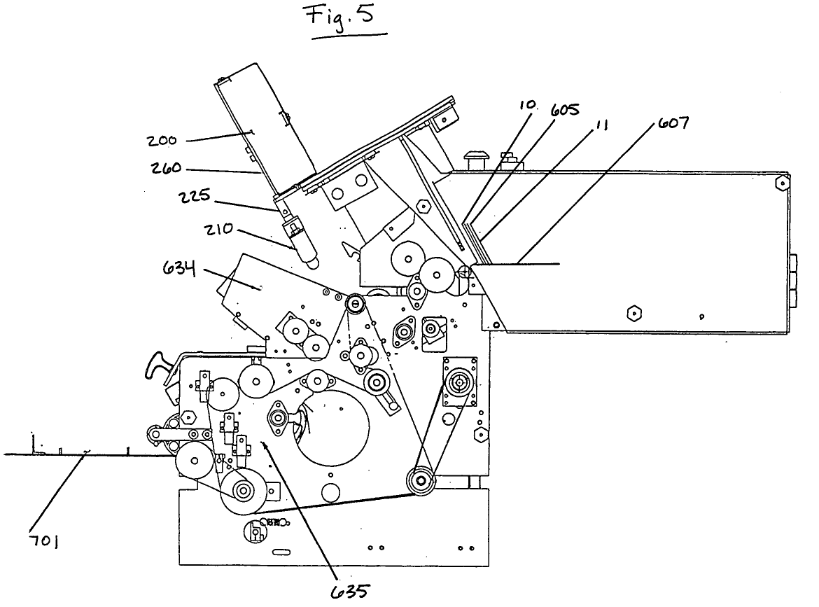

FIG. 5 is a schematic side view of the check feeder device of the present invention.

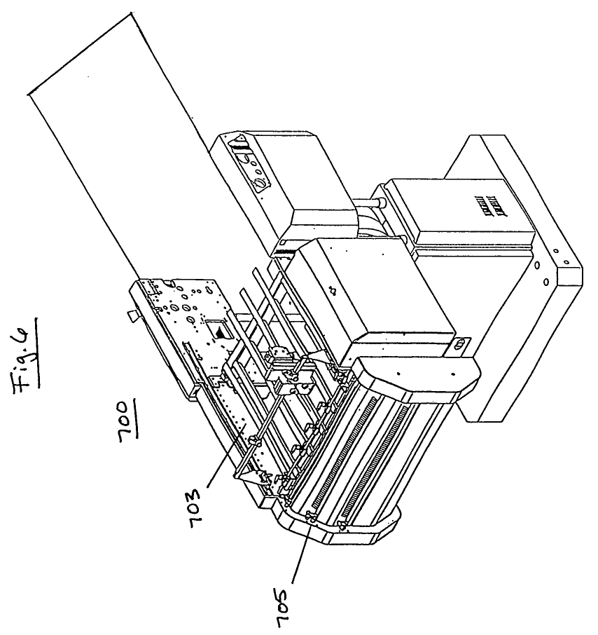

FIG. 6 is a schematic perspective view of the AIM device.

### DETAILED DESCRIPTION OF THE INVENTION

While the invention is susceptible of various modifications and alternative constructions, and may vary with inserter machine configurations, certain illustrated embodiments shown in the drawings will be described below in detail. It should be understood however that there is no intention to limit the invention to the specific forms disclosed, but on the contrary, the invention is to cover all modifications, alternative constructions and equivalents falling within the spirit and scope of the invention.

The system may be installed on check feeder and AIM devices during the manufacturing process or may be installed on pre-existing check feeder/AIM devices using suitable retrofitting equipment, as may be preferred by the user. The check payment verification system may be used with personal check payments, business check payments, or both. The system may also accommodate checks of various types and sizes, as may be required by the manufacturer or user.

Referring to FIG. 1, the MICR code line on a sample check document 10 is in a standard United States MICR standard font, the E-13B MICR standard font, which uses ten characters (0-9) and four symbols that control interpretation of the MICR code line 15 by separating it into several distinct code line fields: an amount symbol (not shown), a dash symbol 20, an On-US symbol 25 and a transit symbol 30. The MICR code line 15 is generally read by readers or sorters from right to left. The amount symbol (not shown) indicates the first field but is generally left blank as banking institutions usually add the amount during processing, although some checks are printed with the amount field numbers. The numbers following the On-US symbol 25 can signify several items, including the account number 31, the bank branch 33 that the check is drawn on, and may also include the check number 35. Although not illustrated in the drawings, larger checks may also include an auxiliary On-US field at the left end of the check. A dash symbol 20 may be used to separate the bank branch number 33 from the account number 31 in the On-Us field 37. The transit symbol 3.0 appears twice, indicating the opening and close of the transit field 40, which indicates the destination for processing. The format of the various fields in the MICR code line may vary to suit the requirements of individual institutions and/or account holders.

Referring to FIG. 2, a preferred embodiment 50 comprises an automatic in-line mailing device (AIM) 700 with a first imaging device 100 and a second imaging device 105, a check feeder device 600 with a check feeder imaging device 200, a black bar detection device 319, a computer 300 with a monitor 400 and an inserter control system (ICS) 500. The monitor 400 displays the functions being carried out by the computer 300.

The AIM 700 may have one or more channels through which bank statements pass through the AIM imaging devices 100, 105. While two imaging devices 100, 105 are illustrated with respect to the AIM 700, it should be understood that only one imaging device could be used. The AIM 700 further comprises an AIM cutter device 705, an AIM collator device 706, an AIM folder device 707 and an AIM dumping device 708.

Bank documents such as statements are loaded onto the AIM 700, where they are imaged via an AIM imaging device 100 and conveyed by an AIM conveyor 701 to a position in front of the check feeder 600. The computer 300 reads and stores the account number information from the statement. Check documents which are presorted into sets or batches, separated by check separators, are loaded onto the check feeder 600, where they are imaged via the check feeder imaging device 200. The black bar device 319 recognizes when a set of checks has passed through the check feeder by detecting a check separator. The set of checks may then be conveyed to the AIM conveyor 701. The computer 300 reads the imaged checks for account number data and matches each check to the other checks within the set and/or to the bank statement that was imaged at the AIM 700 and conveyed to the front of the check feeder 600. The inserter control system 500, in combination with the computer 300, regulates the movement and merger of the checks and bank documents.

The check feeder 600, AIM 700, check feeder imaging device 200, AIM imaging devices 100, 105, computer 300 and inserter control system 500 are connected via a series of communication devices. The computer 300 is connected to the check feeder imaging device 200 via communication line 310, to the black bar device 319 via communication line 320, to the inserter control system 500 via a serial communications line 350, and input/output signals communication lines 360 connecting the inserter control system 500 to the computer 300. The input/output signals communications lines 360 further include an input end of set dump signal communication line 361, an input gate index communication line 362, an output divert signal communication line 363, and an output fault signal communication line 364. The input/output signals communications lines 360 may vary according to the particular configurations of each inserter machine.

The AIM imaging devices 100, 105 may be of the same design as that described for the check feeder imaging device 200. As illustrated representatively in the FIG. 2, multiple AIM imaging devices may be used, preferably one imaging device per each channel of the AIM.

In the preferred embodiment, MICR and OCR software is used to interpret the MICR font characters from the optical images of each check document and to optically read the font characters on a bank document or statement indicating the account number. Any suitable software system may be utilized as required or preferred by the customer to interpret the MICR line. For example, JetVision Gold System software from Intellitech Innovations, Inc., Ontario, Canada, may be used. The AIM imaging devices may also be configured such that only document pages containing account number information are read.

Referring now to FIGS. 3-5, the check feeder is shown from alternate views. Referring to FIG. 3, the check feeder 600 comprises a check feeder imaging device 200, a check tray 11, a conveying platform 607, a check feeder document input device or roller 610, an intermediate roller 620, a check document feeder output device or roller 630, a scanned check document collector 635 and a black bar diverter collector 634. The imaging device 200 comprises a check feeder light source device 210, a check feeder camera 260 and a check feeder trigger device 230 (FIG. 4). The check feeder light source device 210 further comprises a check feeder light source 220 and a check feeder light source mounting bar 225.

As can be seen in FIG. 4, the check feeder trigger device 230 further comprises a check feeder trigger sensor 240, a check feeder trigger amplifier 250, a check feeder trigger 255 and a trigger communication line 258 connecting the trigger device 230 to the check feeder camera 260. In the preferred embodiment, optical fiber cabling is used as the trigger communication line 258 to connect the trigger device 230 to the camera 260.

The check feeder device 600 is shown as comprising a check feeder document input device or roller 610, an intermediate roller 620, a check document feeder output device or roller 630, a scanned check document collector 635 and a black bar diverter collector 634. The check feeder input device or roller 610, intermediate roller 620 and check document feeder output device or roller 630 operate to move the check document through the check feeder device, along conveying platform 607, for imaging and collection of the check documents. In order to enable proper check separation of check documents for imaging, the speed of the check feeder input device or roller 610 is preferably less than the speed of the intermediate roller 620. The differential speed enables check separation prior to entering the imaging area as a check is pulled by the intermediate roller 620.

The black bar device 319 of the check feeder comprises a top photocell sensor 322 and a bottom photocell sensor 323, each of which are connected to the inserter control system 500. The top photocell sensor 322 is positioned above the conveying platform 607 where documents enter the check feeder device 600. The second photocell sensor 323 is positioned below the conveying platform 607 and across from and facing the first photocell sensor 322. Both the first and second photocell sensors 322, 323 each comprise two narrow beam infrared (IR) transmitters and a combination IR transmitter and receiver. The first through beam sensor 322 detects the presence of material and the second through beam indicates when the material has traveled one-quarter of an inch. The data from the sensors is then sent to the ICS, where the reflective contrast of the leading edge of the material is measured. The ICS then determines whether the material is a black bar check separator. A black bar separator document is generally check stock that has two black areas printed across the check stock. If no black bar check separator is detected, the check feeder will continue to operate to image checks. Once detected, the black bar check separators are diverted into the black bar diverter bin as they pass through the check feeder, and the completed check set can be dumped onto conveyor 701.

Referring to FIG. 5, the check feeder 600 is shown positioned adjacent to the AIM conveyor 701 and includes a suitable drive mechanism for operation thereof. The check feeder imaging device 200 is shown positioned above check feeder device 600.

The camera 260, illumination device 210 and trigger 230 are suitably positioned around the check feeder 600, via suitable mounting brackets and related hardware, in such a manner so that the trigger signals the camera to operate when the check is in the desired position for image capture. Locations and mountings may vary as preferred by the user. The check feeder imaging device 200 may image business or personal checks of varying sizes and types, as may be preferred by the user.

In the preferred embodiment of the present invention, an inserter machine user interface (not shown) is connected to the inserter control system and provides machine and job based programming and configuration information to the inserter control system.

FIG. 6 shows a portion of the AIM device 700. Bank statements pass through the AIM cutter device 705 and enter an imaging area where they are imaged by imaging device 100 (not shown) mounted above the AIM imaging area. The imaged statement pages are then collated by the AIM collator device 706, folded by the AIM folder device 707 and then dumped by the AIM dumping device 708 onto the AIM conveyor 701, as described in FIG. 2. The ICS 500 tracks and monitors each bank statement as it travels through the AIM 700, and to check feeder 600.

In operation, the imaging devices 100, 105 and 200 of the preferred embodiment of the present invention 50 are installed on a check feeder 600 and automatic inserter machine 700. Each bank statement document is imaged at the AIM 700 via the AIM imaging device 100 or 105, which transmits the optical image via camera communication line 310 to the computer 300 where OCR software is utilized to read at least a configurable portion of the font characters on the document, and the computer 300 interprets the characters and serially transmits the checking account number data and check count information to the inserter control system 500 via serial communications lines 350. The inserter control system 500 then verifies the account number for length and content and stores the account number as corresponding to the designated bank statement document as it travels through the AIM 700. The entire account number or only a portion of the account number code may be read and stored, as may be preferred by the user. When the bank statement document is dumped from the AIM 700 onto the conveyor 701, the inserter control system 500 sends that document's account number and check count to the computer as validation.

The computer 300 buffers the account number and check count for each statement in the conveyor 701 sections between the AIM 700 and the check feeder 600. The inserter control system 500 uses a machine cycle pulse to transmit a gate index signal via an output gate index communication line 362 to the computer 300 on each machine cycle, indicating to the computer 300 when a specific account number has been cycled to the track location in front of the check feeder 600. The inserter control system 500 then signals the check feeder to dump the corresponding check set onto the conveyor 701. At this time the computer 300 will signal the inserter control system 500 via communication line 364 if an error condition exists in the check set. The computer 300 will also signal the inserter control system 500 via communication line 363 if the operator designates the check set for diversion.

The check feeder device 600 also count each document to determine that the correct number of check documents correspond to each statement. The black bar device 319 of the check feeder 600 may also perform the dual function of counting the number of check documents which pass through the check feeder 600. The computer then matches the check feeder count to the check count read on the bank statement document at the AIM, and stores the check feeder count and the AIM check count in the inserter control system 500. The check feeder 600 and AIM device 700 may each further provide a jam sensor and indicator to detect and alert a material jam.

In a previous process, each check document is sorted into a batch according to account number, and each batch is separated by black bar check separators prior to loading on the check feeder device 600. As a collated set or batch of check payment documents 605 enters the check feeder device 600, the check document feeder input device 610, and intermediate roller 620, move each check 10 through the check feeder device 600 along a conveying platform 607 into the area illuminated by the check feeder light source device 210. In the preferred embodiment, checks are fed into the check feeder 600 vertically and in the downward direction with the MICR code line appearing first. The position and direction of the checks being fed into the check feeder may vary according to the customers' preferences.

As the checks pass through check feeder device 600 the imaging device 200 is activated. Once the check document passes into the area illuminated by the light source device 210, the trigger device 230 is activated as the sensor 240 detects the check. The activated trigger device 230 operates the camera 260 via the trigger amplifier 250, the trigger communication line 258 and the trigger 255, to image the check 10.

In the preferred embodiment of the present invention, a progressive scan array charged-couple device (CCD) digital Videk camera with region of interest (ROI) capability from Videk Company, Rochester, N.Y., is used to capture an optical image of the check document 10 in the region of interest, or the MICR field 15 where the account number is located on the check. After the check 10 has been imaged, it passes to a scanned check feeder collector 635, where the check set is held prior to receiving a signal from the inserter control system 500 to dump the set into the conveyor 701. Although in the preferred embodiment, a Videk® region of interest (ROI) digital progressive scan area array CCD camera is utilized, the imaging devices at the AIM 700 and check feeder 600 may be any device capable of imaging for character recognition using MICR and/or optical character recognition software.

The image of the check document 10 recorded by the imaging device 200 is transmitted via a check feeder camera communication line 310 to computer 300. The computer 300 then uses OCR or MICR software to read and interpret the image of all or a predefined portion of the account number from the MICR code line, converting the information to American Standard Code for Information Interchange (ASCII) whereby the information may be compared to the database of statement account numbers supplied to the computer 300.

The check document account number data is then compared to the corresponding bank document account number data that has been obtained in the AIM 700. The same process is performed for each check document in each batch.

Referring now to black bar device 319, as a document passes through the photocell sensors 322, 323, the reflective IR contrast of the leading edge of the document is measured, and the data is sent to the inserter control system 500 which determines whether the document was a check separator card.

As check separators separating each batch of check documents pass through the check feeder device 600, the black bar device 319 is activated to transmit a black bar signal via an input/output black bar input communications line 320 to the computer 300. The computer then matches each account number for the statement in front of the check feeder 600 with the checks collated in the check feeder collector 635. The account number data from each check in the batch is then verified against the statement account number. The inserter control system 500 then signals the computer 300 via an end of set dump signal communications line 361 that the set of collated checks was dumped by the inserter control system 500 onto the AIM conveyor 701. If an error is detected the computer 300 will signal the inserter control system 500 of the fault via the output fault signal communications line 364. The monitor 400 displays the checks in error, and the operator may validate the error.

After a separator card is detected, it may be diverted to bin 634 for reuse. The same arrangement of photocell sensors 322, 323 may also be used for counting the number of check documents within each set. The method of counting check documents and detecting the end of check sets may vary from that described above, as is known in the art, and/or as may be required by the user.

The computer monitor 400 displays the status of the operation. The operator may choose to allow the check batch or set to continue processing or may divert the check set, in which case the computer 300 signals the inserter control system 500 via communication line 363 to divert the check set for offline handling via a divert signal. Alternatively, individual mismatched checks may be diverted without diverting the entire set of check documents. Diverted individual check documents, check document sets and/or check sets and bank documents may be diverted either at the check feeder prior to merger with a corresponding bank document or after merger at the AIM conveyor 701. The mismatched item may also be marked as being a mismatched and/or diverted document via a printing mechanism. The inserter control system 500 can be configured to have the envelope of error-diverted statements marked, including but not limited to, by a mechanical ink marker. The computer 300 may also be set to disable operator error validation functions and to divert all error sets, eliminating the need for operator validation on the computer monitor 400.

The preferred embodiment further comprises several other user and/or operator selectable features, such as, but not limited to, check feeder account number masking, character tolerance, set mismatch tolerance, disabling of operator error validation such that all error sets are diverted, and parenting of multiple account numbers, as described next. The inserter control system utilizes a unique setting to activate special reading and verification programs as well as disabling the account number reading on non-info page statements.

For MICR font character masking, a portion of the characters read at the computer 300 may be masked such that only targeted character positions are read. For example a check sequence of 1234 could be masked as X3X4 and would be interpreted as matching a sequence of 2324 or 1334. Different levels of significance may also be assigned to various font character positions.

The present verification system may also be operated at varying character mismatch tolerance levels, whereby insignificant digits that do not match will not trigger a mismatch error.

The system may also use a check count mismatch device, whereby an error is triggered if the expected number of checks counted by the system do not match the expected number of checks.

The system may also provide mismatch set tolerance, which alerts the operator when a preset number of consecutive error sets have occurred.

The system may further provide parenting of multiple account numbers in which related account numbers are indexed in a database for treatment as matching account numbers for a single statement.

The computer 300 may also further comprise a noise suppression board to eliminate electrical noise on the camera triggering circuitry.

Although the invention is described above as utilizing account number information, for example, via MICR and OCR font software, other account information may be used, read, and/or compared in order to determine if check statements and check sets match, such as one or more of the following: the name and address of a bank customer, the check number, the amount of each check, the logo, style of font, font size and/or check background images on each check, or any other information on a check that could be matched to corresponding information on a bank statement. The specific account information used to determine a match may vary as required by the user.

It is to be understood that the embodiment(s) herein described is/are merely illustrative of the principles of the present invention. Various modifications may be made by those skilled in the art without departing from the spirit or scope from the claims which follow.

1. A method for check payment verification, comprising the steps of:
obtaining account information from a check document;
comparing the account information from said check document to account information from a bank document to verify a match; and
associating the check document with the bank document upon verifying a match.

2. A method for check payment verification, comprising the steps of:
capturing an image of at least a portion of each of a plurality of check documents in a set of check documents;
determining account information from said image for each of the plurality of check documents;
comparing the account information of at least one said plurality of check documents to the account information of at least one other check document in said set of check documents to determine a match.

3. The method of claim 1, wherein the step of obtaining further comprises the step of:
capturing an image of at least a portion of said check document.

4. The method of claim 1, wherein said bank document is a bank statement.

5. The method of claim 1, wherein said method is employed during a mail insertion operation.

6. The method of claim 1, further comprising the steps of:
monitoring the position of said bank document; and
regulating merger of said check documents with said bank document.

7. The method of claim 6, further comprising the step of:
identifying mismatches between check documents and said bank document.

8. The method of claim 8, further comprising the step of:
halting said set of check documents containing said identified mismatched check document.

9. The method of claim 9, further comprising the step of:
signaling an operator when a mismatched document is identified.

10. The method of claim 9, further comprising the step of:
diverting said set of check documents containing said identified mismatched check document.

11. The method of claim 12, further comprising the step of:
diverting said bank document containing said mismatched document.

12. The method of claim 7, wherein said mismatched document is marked as mismatched error document.

13. The method of claim 1, wherein said account information is a character string comprising a plurality of characters.

14. The method of claim 1, wherein said account information is matched using mismatch tolerance levels.

15. The method of claim 2, wherein said check set is matched with at least one second set of check documents, wherein each set contains account information for related accounts.

16. A method for check verification comprising the steps of:
passing a check document set through a check feeder device, wherein said set comprises at least one check document;
imaging each check document in said set via an imaging device to create an image;
determining account information for each check document from each said image;
comparing said account information from each check document in said set to account number information on a bank document.

17. The method of claim 16, further comprising the steps of:
loading a bank document onto an automatic inserter machine;
imaging said bank document via a second imaging device;
determining account information for said document;

18. A device for check payment verification, comprising:
an imaging device, wherein said check document imaging device images at least a portion of each check document in a set of check documents; and
a computer, said computer in communication with said imaging device, wherein said computer reads at least a portion of said image of each said check document for account number information and compares the account information of each check document in said set to account information from every other check document in said set.

19. A device for check payment verification, comprising:
an imaging device, wherein said imaging device images at least a portion of each check document in a set of check documents; and
a computer, said computer in communication with said imaging device, wherein said computer reads at least a portion of said image of each said check document for account information and compares the account information of each check document in said set to account information from a bank document to determine a match.

20. The device as claimed in claim 19, further comprising:
a bank document imaging device, wherein said bank document imaging device images at least a portion of said bank document containing account number information;

21. The device as claimed in claim 20, wherein said imaging device comprises:
a light source, said light source illuminating said document;
a camera, said camera positioned to obtain an image of at least a portion of said check document;
a trigger device; said trigger device sensing said check document and activating said camera to obtain an image of said check document.

22. The device as claimed in claim 21, wherein said trigger device comprises:
a trigger sensor, positioned to sense the presence of a document;
a trigger mechanism operatively connected to said imaging device for activating said imaging device; and
a trigger amplifier, operatively connecting said trigger sensor and said trigger mechanism.

23. The device as claimed in claim 21, wherein said imaging device is a digital, region of interest camera.

24. A check verification system comprising:
an automated in-line mailing device (AIM), having a bank document imaging device positioned to image bank documents traveling along an AIM conveyor;
a check feeder, having a check document imaging device positioned to image check documents merging with said AIM conveyor;
a computer for processing images obtained from the bank document imaging device and the check document imaging device for comparison of account information;

25. The system as claimed in claim 24, further comprising:
a document control system, said document control system in communication with said computer, wherein said document control system operates with said computer to regulate said check documents and said bank statements during a mail insertion operation.

26. The system as claimed in claim 24, further comprising:
a control panel, said control panel in communication with said computer.

27. The system as claimed in claim 25, wherein said check feeder device further comprises:
a drive assembly for controlling the rate of checks passing through the check feeder.

28. The system as claimed in claim 24, wherein said check feeder is halted when a mismatch between said bank document and said check document is detected by said computer.

29. The system as claimed in claim 24, wherein said check feeder marks mismatched check documents for diverting.

30. The system as claimed in claim 24, wherein said check feeder diverts mismatched check documents

31. The system as claimed in claim 24, wherein said AIM diverts mismatched checks and statement documents.

32. The device as claimed in claim 19, wherein said account information comprises a character string of numbers.

34. The device as claimed in claim 21, wherein said computer matches check document sets which contain related account information to said bank document.

35. The device as claimed in claim 21, wherein said computer matches said check documents to said bank documents using selectable mismatch tolerance levels.

36. A device for check payment verification, comprising:
means for determining account information from each check in a set of check documents;
means for determining account information from a bank statement; and
means for determining whether said check document account information matches said bank statement account information.
